(19) United States
(12) Patent Application Publication
(10) Pub. No.: US 2008/0126537 A1
(43) Pub. Date: May 29, 2008

(54) METHOD FOR AUTOMATIC DEFINITION AND ASSEMBLY OF COMPOSITE PORTAL APPLICATIONS

(76) Inventors: Jan Engehausen, Boeblingen (DE); Jean-Baptiste Joret, Leinfelden (DE); Timo Kussmaul, Boeblingen (DE)

Correspondence Address: HOFFMAN, WARNICK & D'ALESSANDRO LLC, 75 STATE ST, 14TH FLOOR, ALBANY, NY, 12207, US

(21) Appl. No.: 11/847,592

(22) Filed: Aug. 30, 2007

(30) Foreign Application Priority Data
Nov. 23, 2006 (EP) 06124611.2

(51) Int. Cl. G06F 17/30; G06F 15/16

(52) U.S. Cl. 709/224; 707/102; 707/E17.005

(57) ABSTRACT

The present invention is directed to a method and system for configuring portal applications in web-based environments. A method in accordance with an embodiment of the present invention includes: automatically capturing and storing user browsing navigation data; reading portal configuration data corresponding to a user-browsed portal; automatically analyzing the configuration data and the stored browsing navigation data according to a set of predetermined criteria; automatically generating configuration data based on a result of the automatic analyses; and creating from the automatically generated configuration data a representation of a new composite portal application comprising application parts which are typically browsed by a user.

### BACKGROUND OF THE INVENTION

1. Field of the Invention

The present invention relates to the field of network computing, and in particular to a method and system for configuring portal applications in web-based environments, wherein a plurality of application parts are combined on a portal to build a composite application.

2. Related Art

Portals provide end users with unified access to content, applications, and collaboration services in a highly personalized manner. An example is IBM's WebSphere Portal, which provides a middleware framework and tools for building and managing portals using component applications called “portlets”.

FIG. 1 depicts a schematic system view of a web server implementing a prior art portal.

A portal is typically implemented on a network server, for example a web server 100, which includes various logic components for user authentication 105, state handling 110, and aggregation 115 of fragments. The web server 100 further includes a plurality of portlets 120 provided in respective pages 125, with a respective plurality of APIs 130 to a respective portlet container software 135 for setting the pages 125 into a common web page context, and some portal storage resources 140. The logic components are operatively connected such that data can be exchanged between single components as required.

A portal engine of the web server 100 in FIG. 1 implements an aggregation of portlets 120 based on an underlying portal model 150 and portal information such as security settings, user roles, customization settings, and device capabilities. Within a rendered page 125, the portal automatically generates the appropriate set of navigation elements based on the portal model 150. The portal engine invokes portlets 120 during the aggregation as required and when required and uses caching to reduce the number of requests made to the portlets 120.

The portlet container 135 is a control component responsible for all portlets 120, which may control the execution of code residing in each of the portlets 120. The portlet container 135 provides the runtime environment for the portlets 120 and facilities for event handling, inter-portlet messaging, and access to portlet instance and configuration data, among others. The portal resources 140 include, for example, the portlets 120 themselves and the pages 125 on which they are aggregated in form of an aggregation of fragments. A portal database 128 stores the portlet description, which can include, for example, attributes such as portlet name, portlet description, portlet title, portlet short title, and keywords, as well as the portlet interaction interface description, which is often stored in form of WSDL documents. The portal database 128 also stores the portal content structure, i.e., the hierarchical structure of portal pages, which may contain nested pages, and portlets. This data is stored in the portal database 128 in an adequate representation based on prior art techniques like relational tables.

The aggregation logic 115 includes the steps that are required to assemble a page 125. Typically, these steps include loading a content structure from storage, traverse the content structure, and calling the instances referenced in the content structure in order to obtain their output, which is assembled to a single page 125. The content structure may be defined, for example, through administrative interfaces by the administrator.

FIG. 2 depicts the server logic in a typical prior art portal system. The server logic usually includes an application server 4 on which the portal infrastructure is based. The portal server 6 itself offers on-top services such as the portlet container 135, aggregation functionality 170, and access control (e.g., authentication) 105 for resources managed by the portal.

A portal resource management component 140 manages the configuration of resources of the application server 4, including, for example, servlets, Enterprise Java Beans, Java Server Pages (JSPs), etc. (Java and all Java-based trademarks are trademarks of Sun Microsystems, Inc. in the United States, other countries, or both). Such configuration of resources is formally expressed through pre-defined interfaces, such as XML files describing the resources (e.g., web.xml of a web application). The same is true for resources provided by a portal server.

The portal server 6 offers services to create, read, update, and delete (CRUD) its resources. These services can be delivered in many different variations; updates may be made through XML descriptions of resources sent to the portal server 6, by command-line based scripting interactions with the portal server 6, or by directly interacting with user interfaces provided by portal itself.

In a business environment closely integrated into the web, application servers are often used to provide access to applications. Portals usually build on top of application servers and formalize elements of such applications. In addition to potentially existing business objects and services of an application, a portal introduces the concept of the before mentioned portlets and pages. Portlets form parts of or a complete application. Pages are used to group portlets and other content into logical parts.

A composite application is an application composed of parts. Portals offer a variety of parts such as portlets, pages, branding elements (themes and skins), business objects (such as EJBs), etc. Composite applications represent entities manageable by on-demand concepts such as provisioning, application management, and assurance of quality of service.

The prior art concept of a composite application results in the necessity to describe such applications. Established patterns such as XML representations of composite applications can be used for this purpose. In particular, existing resource representations may be referenced or included in a composite application configuration description.

In order to illustrate these aspects, an architectural diagram of a portal server with focus on portal interaction flow and resource access is depicted in FIG. 3.

In the main processing flow of a portal, a request is sent to the server where it is processed and answered. The first step in processing a request is to verify (310) that the sender is authenticated to interact with the server. The result of this verification influences the response of the server; if the sender is not correctly authenticated the request may be denied or the sender is prompted to provide credentials.

In 320, the navigational state which represents the state of portal resources for a particular request is deserialized and prepared for modifications or for again serializing the navigational state into URLs or other appropriate storage. The navigational state may contain actions which are to be executed when a request transporting this state is sent to the portal. This is done in the action processing phase (330), which executes the encoded actions. These actions may modify server-side state, resources that can be managed through portal, and/or influence the generation of the response.

Finally, a response is generated in the aggregation phase (340) based on the navigational state valid for the request. The aggregation accesses resources information to aggregate markup from different sources, and writes the combined output to the response, after which processing of the request ends (350).

Any component may use the event communication layer 380 to issue or receive events processed by event handlers 370. In particular, any component may issue instructions to log its activities (385).

To perform their operations, any component associated with 310-350 may need to access information on portal resources. For example, this includes information on access permissions for resources, or on properties of particular resources. This is done through a resource access and administration layer 390.

Both the event communication layer 380 and the resource access and administration layer 390 may also be accessed outside of the depicted main flow above, for example through EJBs, command line interfaces, or other code that is not contained in the request/response cycle which often forms the basis of interactions with a portal.

A person skilled in the art will appreciate that in the prior art, composite application are always built manually, and much effort has to be spent to build the application as this requires complex J2EE and portal skills, which range from the programmatic part requiring code-related skills, via the look and feel design of the user interface, to packaging. Thus, it includes J2EE concepts such as WAR/EAR files, and application container formats.

Disadvantageously, these skills are often distributed across a complete team. Creating a composite application is thus usually an ineffective process. Further, it is possible that manually created composite applications do not fully cover related entities in an operating environment. In other words, the complexity of the operating environment makes it hard to fully and precisely detect valuable composite applications.

### SUMMARY OF THE INVENTION

The present invention provides a method and system for automatically configuring composite portal applications, which reduces the manual work of the application developer and concurrently generates more user-friendly portals.

A method and system for automatic definition and assembly of composite applications in a portal environment is disclosed. The system of the present invention incorporates a so-called “Automatic Application component” that determines composite applications based on the resources and the configuration of the operating environment, and on how the system is used. Use of this method results in a set of composite application definitions, which may be further processed, for example by means of a user interface incorporated into the system, or by further automatic tasks, such as an automatic rating system.

According to an aspect of the present invention, there is provided a method for configuring portal applications in web-based environments, wherein a plurality of application parts are combined to provide a composite application, comprising: automatically capturing and storing user browsing navigation data; reading portal configuration data corresponding to a user-browsed portal; automatically analyzing the configuration data and the stored browsing navigation data according to a set of predetermined criteria; automatically generating configuration data based on a result of the automatic analyses; and creating from the automatically generated configuration data a representation of a new composite portal application comprising application parts which are typically browsed by a user. The new portal configuration can be offered for a user or a user group to be installed instead of or in addition to the pre-existing portal configuration.

The present invention automatically defines a composite portal application or a set of composite portal applications is automatically defined according to the monitored use of portal resources. In more detail, a set of (i.e., one or more) composite applications contains all the portal resources that are necessary to carry out one or multiple tasks that are typical for one or more groups of users. The resulting composite application can be exported from the portal in an external representation and can be imported into further portals, thus providing all application functionality that is required for one or multiple groups of users.

In accordance with the present invention, the following terms are defined as set forth below.

Tracking: This means capturing and recording information about activities taking place in the system. Usually, activities are announced through events. Tracking is achieved by listening to specific events which are then recorded. The representation of the event may be changed by the listener receiving the event from the source that fires the event. For example, an event might contain more information than is required for the purpose of tracking and later analysis (e.g., information on specific user settings are transported, but all that is important for this specific event is the identity of the user). While normal logging would just write out the information to a log, this information can be transformed beforehand for easier analysis.

Events: This concerns the occurrence of an activity that has happened and has been registered; for example a user logging in, viewing specific resources, customizing or managing the specific resources, etc. Typically, runtime components of complex systems use events to indicate certain occurrences of activities taking place.

Portal configuration data: This is the data a portal operates on in order to perform its functions. This is data that defines how the portal operates and what it ultimately displays. Prominent elements are pages and portlets. Part of the configuration data of the prior art IBM WebSphere Portal, for example, is the representation of pages, portlets, themes, and skins (amongst other artifacts), which can be exposed through a “XML Access” XML file. An example of such an XML file is depicted in FIG. 3B. In order to improve clarity, this example is extremely simplified, as the original file would be too long.

Logged data: This is data captured by the tracking process, i.e., the information stored by logging services or listeners for specific events.

Predetermined criteria: These are descriptions of the information relevant for the analyses described later below and extractable from events or logged data.

The automatic analyses in accordance with the present invention can be performed in a user-specific way, wherein the criteria are selected also user-specifically, and wherein content is also selected user-specifically. To this extent, a programmer's work is substantially simplified when it is required to offer portal customization or portal layout specification according to the before-mentioned user groups and the respective user-specific user needs.

For example, in an enterprises portal accessible only for enterprises staff members, different portal configurations may be automatically generated which reflect these specific needs, for example, for management, technicians, etc. As another example, in the public domain, user groups maybe distinguished according to age, sex, hobbies, language, “browsing behavior”, etc.

In an illustrative case, when a user needs to click on a number (e.g., three) of distinct portlets and the tracked user behavior shows that the user must navigate between a plurality (e.g., four) pages, including scroll-up and scroll-down, a new configuration provided by the invention can be locate those three portlets next to each other on the same webpage. By that, page changing and scrolling can be avoided. Thus, the user experience (e.g., “comfort”) is significantly increased.

Using the present invention, a user (e.g., an application engineer) who must generally provide high user comfort in web applications, needs only to watch the proposals of new portal configurations, which are generated by the present invention, and can select such a proposal and install it at the portal server. Alternatively, the user can accept the automatically generated configuration just as proposed and can amend this proposal according to his/her own experience. In both alternatives, the user saves much manual work.

The new portal configuration can be stored in an archive file, for example, an XML file, a WAR file, an EAR file, or a PAA file comprising all artifacts of the new portal configuration. Such artifacts cam include a page, a portlet, EJB, JSP, HTML-pages, images, etc. Such archive files can then be exported and/or further processed according to standard handling in order to be easily used for installing a new portal configuration at an portal server.

Further preferably, in accordance with an embodiment of the present invention, an automatic analysis procedure is used which models a portal configuration in a graph-like structure. Here, the graph structure can be a net showing meshes, or it can be also a tree without meshes. In the latter case, the nodes are objects which are used as a navigational point, as for example a page, wherein leaf nodes are objects which are used as a target during navigation. The leaf nodes need no further distinction in the sense of the present invention. Examples of leaf nodes are portlets, images, and in general static resources stored on a file system which do not change during run time of the portal application.

### BRIEF DESCRIPTION OF THE DRAWINGS

These and other features of the invention will be more readily understood from the following detailed description of the various aspects of the invention taken in conjunction with the accompanying drawings.

FIG. 1 depicts illustrative components of a hardware and software environment of a portal server for providing a web portal in accordance with the prior art.

FIG. 2 depicts illustrative components of a prior art web server environment.

FIG. 3A illustrates in an interaction diagram the processing between the application server and the portal server depicted in FIG. 2.

FIG. 3B is an extraction from an “XML Access” XML file, representing a prior art portal including pages, portlets, themes, and skins.

FIG. 4 depicts illustrative components of a web server environment including an extended portal server in accordance with an embodiment of the present invention.

FIG. 5 depicts a schematic control flow diagram of an illustrative procedure for asynchronous capturing data in accordance with an embodiment of the present invention.

FIG. 6 depicts a schematic control flow diagram of an illustrative procedure for synchronous capturing data in accordance with an embodiment of the present invention.

FIG. 7 depicts a schematic control flow diagram of an illustrative procedure for applying the interaction data to a portal configuration graph in accordance with an embodiment of the present invention.

FIG. 8 depicts a schematic control flow diagram of an illustrative procedure for transforming a weighted data graph to composite applications in accordance with an embodiment of the present invention.

FIG. 9 depicts an illustrative graph of a page and portlet setup of a portal in accordance with an embodiment of the present invention.

FIG. 10 is a table representation illustrating sample data for graph nodes in accordance with an embodiment of the present invention.

FIG. 11 is a schematic depiction of a graph illustrating a page and portlet setup of a portal when partitioned for a specific user group denoted “HR” in accordance with an embodiment of the present invention.

FIGS. 12A, 12B, and 12C depict an exemplarily selected XML access representation of a sample page and portlet setup corresponding to the setup of FIG. 9.

FIGS. 13A and 13B depict an excerpt from the composite application definition of the “HR” composite application.

### DETAILED DESCRIPTION OF THE INVENTION

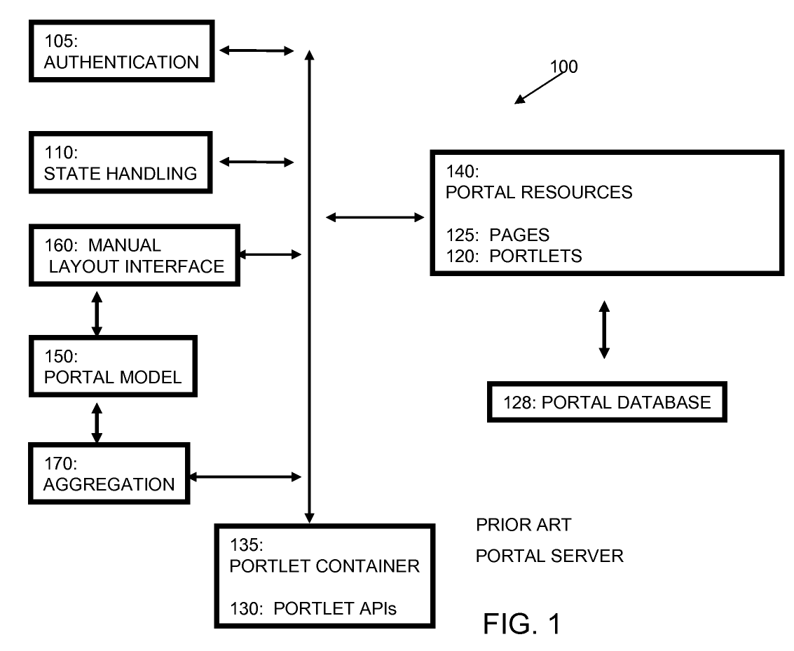

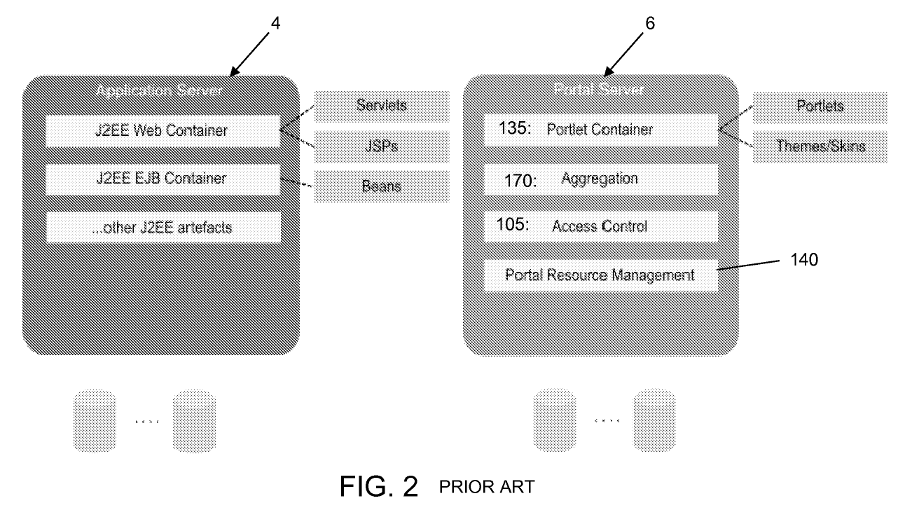

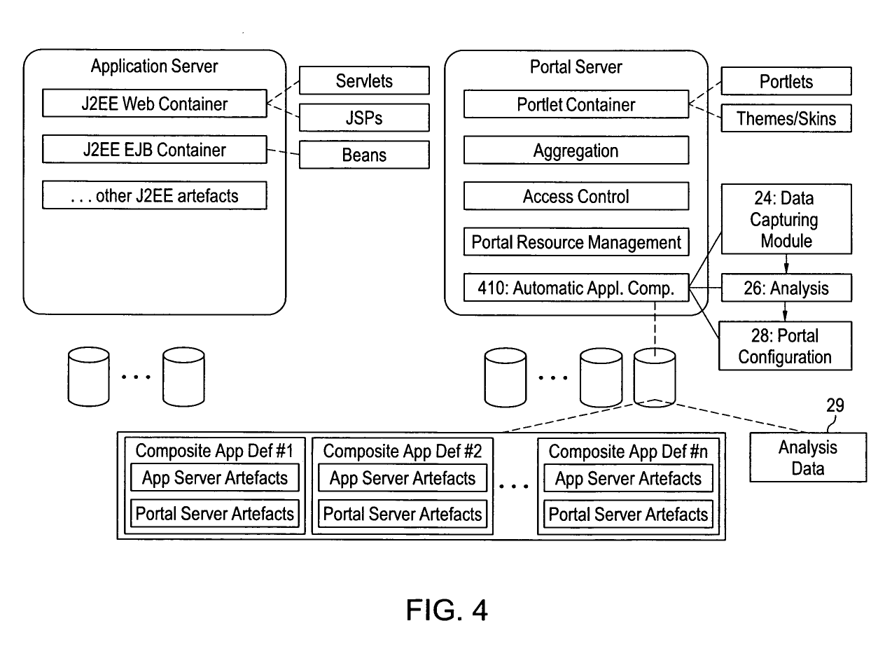

A comparison between FIG. 2 and FIG. 4 depicts some of the differences between the prior art and the web server environment in accordance with an embodiment of the present invention. The present invention can be implemented in a single or in a plurality of program modules within the portal server 6. It uses functional interfaces including all necessary APIs to functional components, such as the portlet container 135 (FIG. 1), aggregation component 170, access control 105, portal resources 140, etc.

As shown in FIG. 4, there is provided an automatic application component (AAC) 410, which includes the following subcomponents: 1) an automatic data capturing module 24, an automatic analysis component 26; and an automatic portal configuration component 28. Each of the components 24, 26, 28 is provided with an interface in order to access the analysis data 29 comprising the before mentioned logging data, which comprises historic user behavior.

Next, details of an illustrative implementation of the automatic data capturing module 24 are described.

Prior art portals usually comprise an event monitor, which tracks most of the user behavior, at least in so far as the user behavior triggered a web request which is received and processed by the web application server. For example, a click on a link is tracked as the request is received. The prior art event monitor maintains a log file, in which all such events are stored. The requests for a certain web site, for a particular portlet, or for a special link to any other linked data object are tracked.

The present invention employs this tracking procedure and accesses the respective log file for a read access for reading all relevant navigation data. From this event data collection, all relevant information on user behavior can be extracted for the purpose of the present invention. To this extent, given a sufficiently detailed log data source, the present invention processes the data, whereas in absence of such log data sources the present invention just listens itself to those events and stores the respective navigation data in its own data store. Particular log content can include the following data: time of the event; the user ID- or IP-address of the user; and the address resources (e.g., portal pages, portlets, images, HTML pages, etc.).

In addition, the automatic data capturing module 24 of the invention, either working synchronously through event listeners or asynchronously by analyzing logs, checks the user ID if this seems to be useful, and parses the addressed resources by, for example, URL parsing, etc. For the sake of the present invention, it is not relevant if the data collecting procedure is performed using prior art action handling or prior art rendering steps, as long as the data is collected properly and, optionally with the proper relationship to the user ID or user group ID, if present.

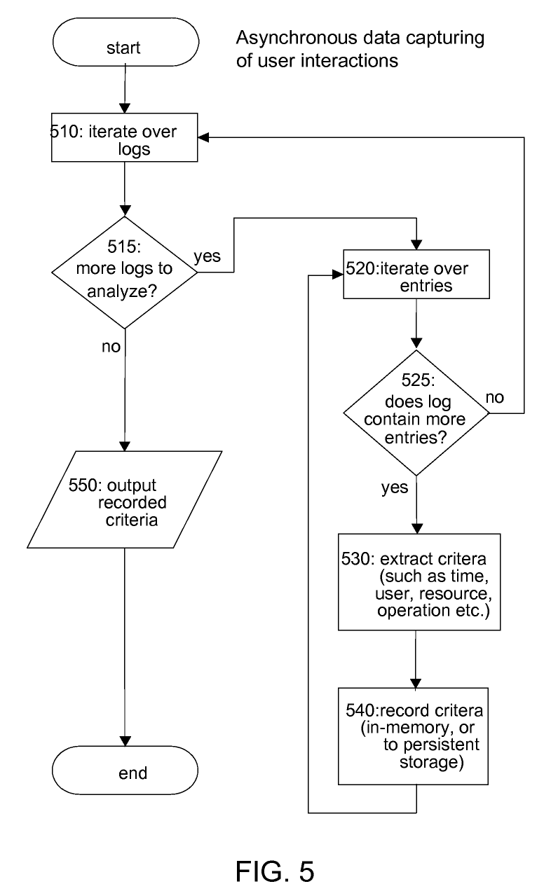

With additional reference to FIG. 5 as a part of event collection, the process of asynchronous data capturing of user interactions is described in more detail.

To automatically generate composite application definitions, data describing user interactions with the portal and its resources first needs to be collected. The basic procedure followed here when capturing of information on user interactions is to analyze log files. As the log file exists before the data thereof is captured, this is denoted “asynchronous”. Any log file the server or its infrastructure generates may be used. Logs from auditing or site analysis components are suited in particular. The following is an example from an IBM WebSphere Portal site analysis log:

9.37.3.88 - customer2 [10/Apr/2002:21:33:16 +0000]
“GET
/Portlet/146/Welcome_Portlet?PortletPID=146&PortletMode=
View&PortletState=Normal
HTTP/1.1” 200 -1 “http://myserver.company.com/Page/110/Welcome”
“Mozilla/4.0 (compatible; MSIE 5.5; Windows NT 4.0)”
“JSESSIONID=OXDFAPVR2SXYZOIHSLVGA4Y”

This site analysis log uses the NCSA combined log format, which is a combination of NCSA common log format and three additional fields: the referrer field; the user agent field, and the cookie field. The automatic data capturing module 24 can use this type of log as well as other types.

FIG. 5 depicts a schematic control flow diagram of an illustrative procedure for asynchronous capturing data in accordance with an embodiment of the present invention.

The control flow iterates over a set of logs in 510 and 515, and, in 520, for each log, iterates its entries. Each entry is analyzed and relevant interaction criteria are extracted in 530. This data can comprise, for example, the time at which the interaction occurred, or the user who performed the interaction on the resource, and what kind of operation was performed. The criteria are then recorded in 540, for instance, in persistent storage (e.g., in memory, in a database, etc.). When all entries of all logs are completely iterated, the recorded criteria information is output in 550.

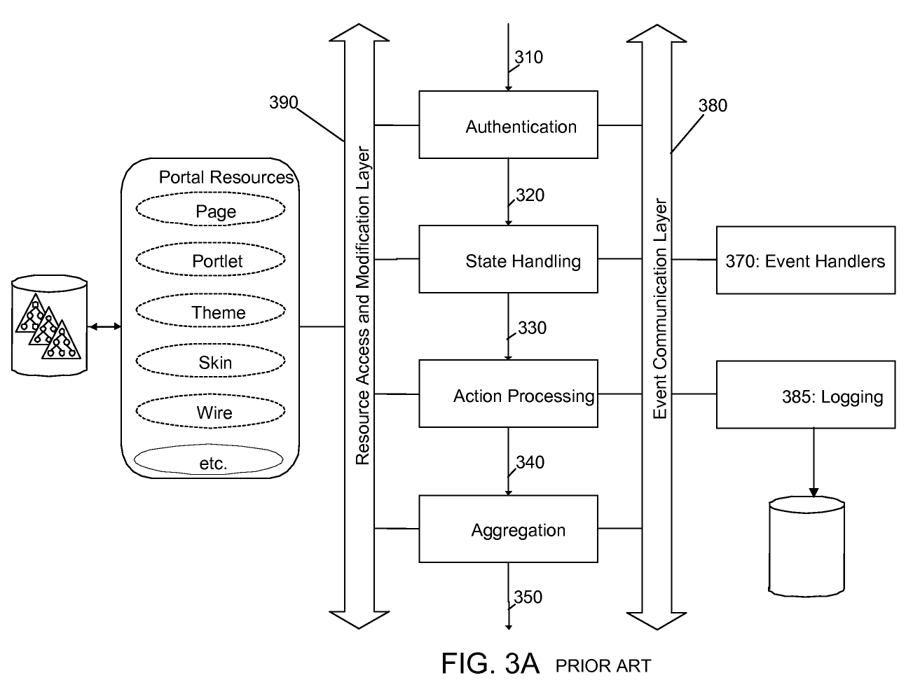

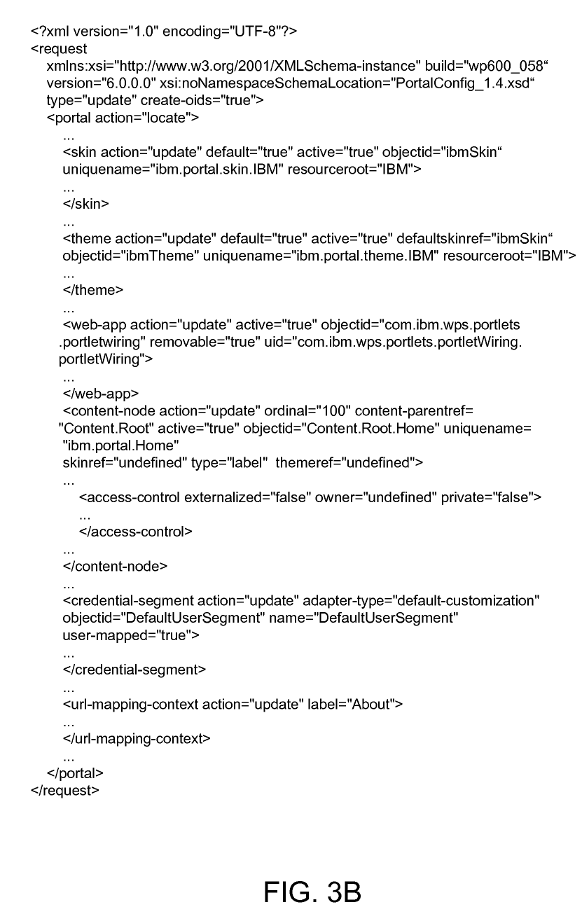

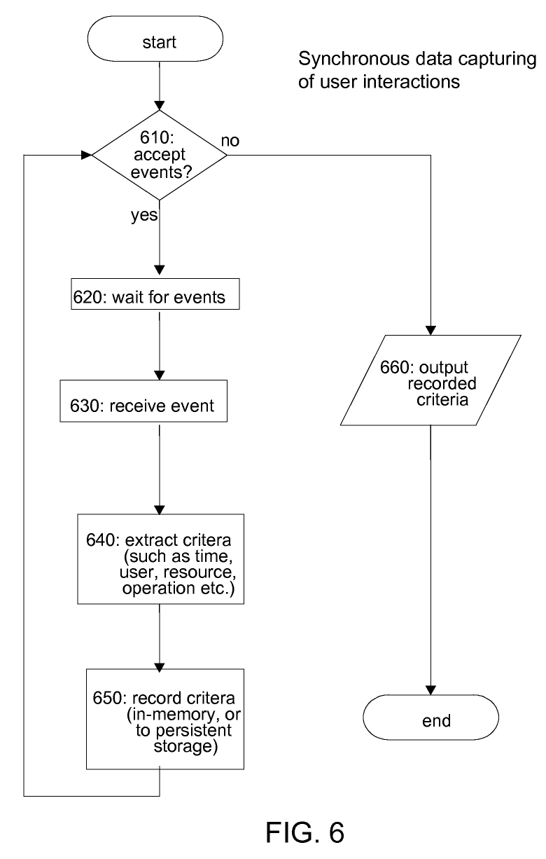

Instead of analyzing information that was written into logs, the data capturing component can also use the event communication layer mentioned above (see, e.g., FIG. 6 and FIG. 3). In this alternative processing mode, the data capturing takes place synchronously, i.e., at the time the interaction occurs.

As depicted in FIG. 6, in 610, 620, the component waits for events it is interested in. If an event occurs, it is received in 630. The event will transport information similar to what could be found in logs. Relevant interaction criteria are extracted from the event information in 640. This can include, for example, the time at which the interaction occurred, the user who performed the interaction on the resource, and what kind of operation was performed. The criteria are then recorded in 650, for instance, in persistent storage (e.g., in memory, in a database, etc.). Once the component is told to stop listening for events, it outputs the recorded criteria information in 660.

The portal configuration can be represented as a graph that represents the resources and their relationships. All artifacts of the environment can be used, for example, pages, portlets, page wires, EJBs, JSPs, etc. The individual resources are represented as graph nodes, and the relationships between resources are represented as edges. Edges or nodes can be weighted. Node weights can include statistical information that represents frequency of use of the resource, frequency of customization/modification, etc.

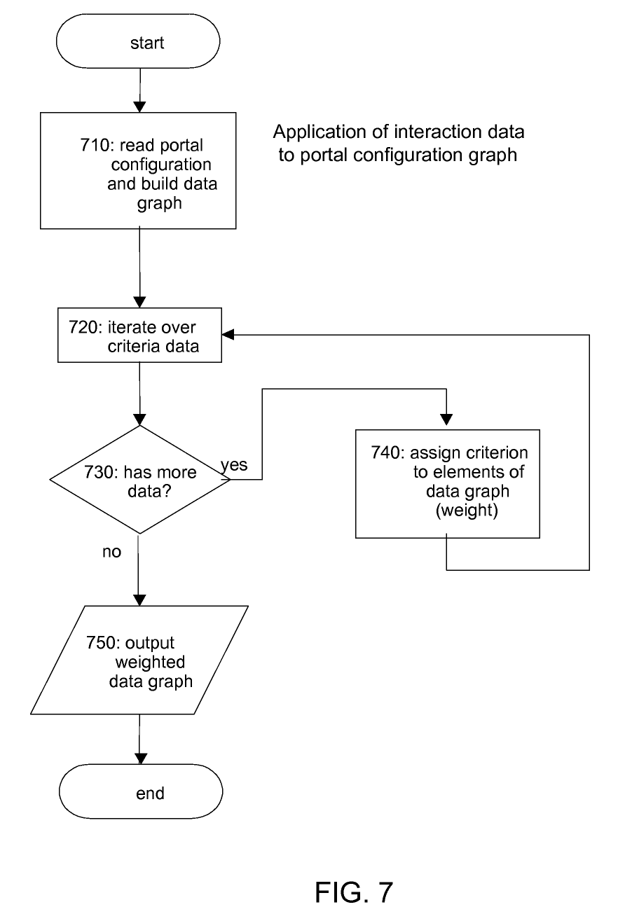

With reference to FIG. 7, the output of the data capturing component is now processed by the analysis component 26 (see, e.g., FIG. 4), and the criteria data are applied to the full configuration graph.

First, the complete portal configuration information is read and the data graph is built from this information in 710. The criteria data created in the data capturing component are then iterated for assignment in 720. In particular, the information for each criterion is assigned to applicable elements of the data graph as weight, wherein a weighting might be applied to nodes or edges of the graph in 730, 740. Once all criteria are assigned to the data graph, the weighted data graph is output by this component in 750.

The weighted data graph built as described above forms the input for the transformation and output component.

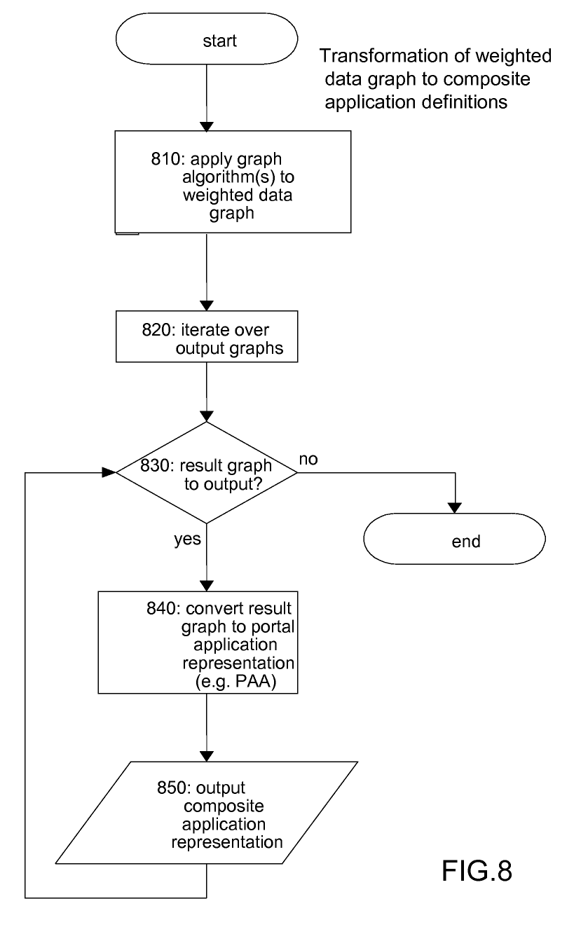

With reference to FIG. 8, the graph is transformed by the before-mentioned portal configuration component 28 through graph algorithms to form new graphs. The new graphs form the basis for composite application definitions as described below.

With the weighted data graph as input, a set of graph algorithms is applied in 810, resulting in a set of transformed graphs. Each graph is iterated (820, 830) and converted into a composite application definition in 840, for example into IBM WebSphere Portal “Portal Application Archive” (PAA) format and is then output in 850 as a result of the transformation component.

The transformation output graph is obtained by using one or more algorithms which partition the graph. The input graph is partitioned by qualifying the existing nodes and edges as either “desired” or “undesired” through a rating system, which compares the weights with threshold levels. The output graph only contains “desired” nodes and edges. This process can be repeated with varying threshold levels to obtain different output graphs relevant for specific use cases.

### EXAMPLE

A company uses a portal to offer in-house services to its employees. For this, a portal was manually set up by portal administrators, who deployed a set of portlets bought or developed internally for providing the services. The following portlets were used: employee directory portlet; currency calculator portlet; travel booking portlet; helpdesk portlet; site search portlet; and travel expenses accounting portlet.

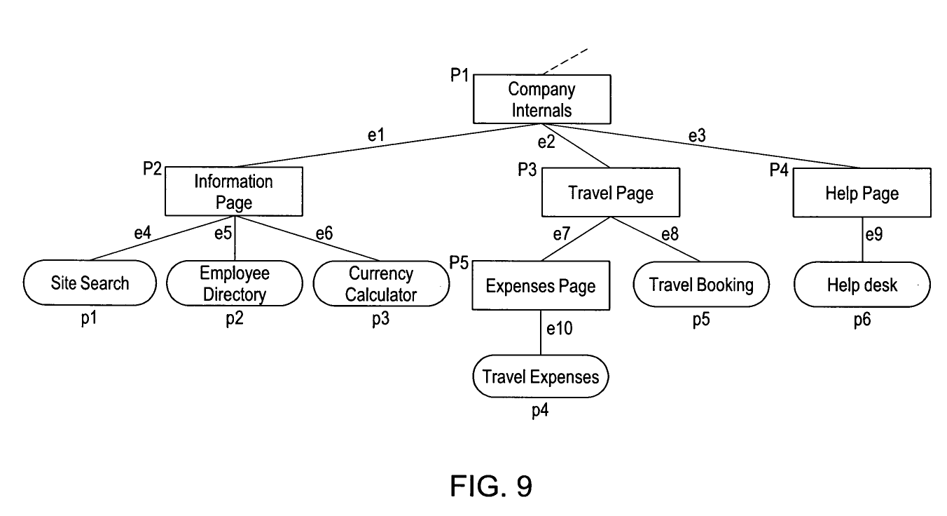

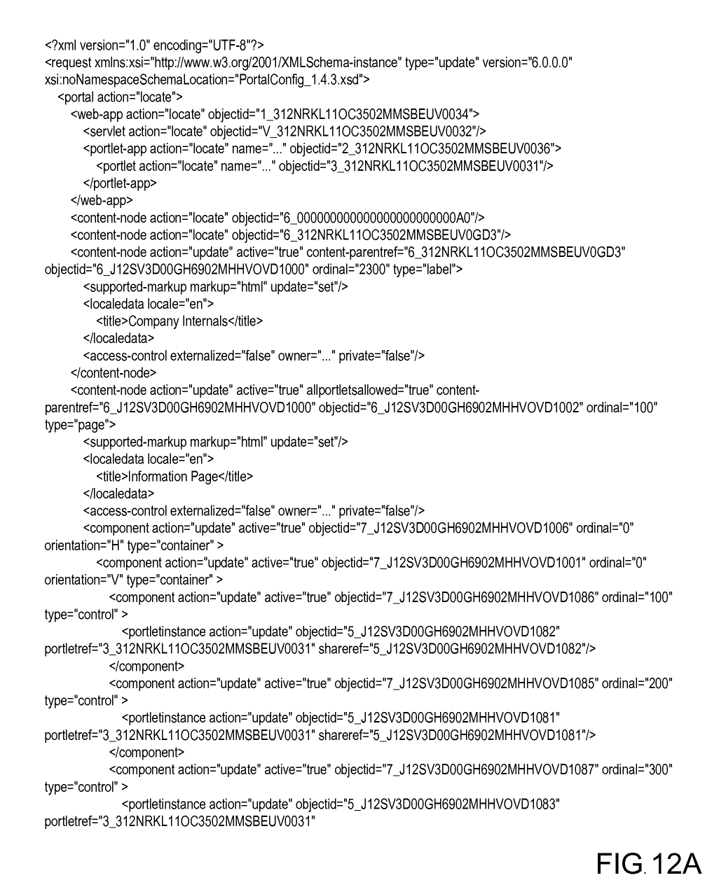

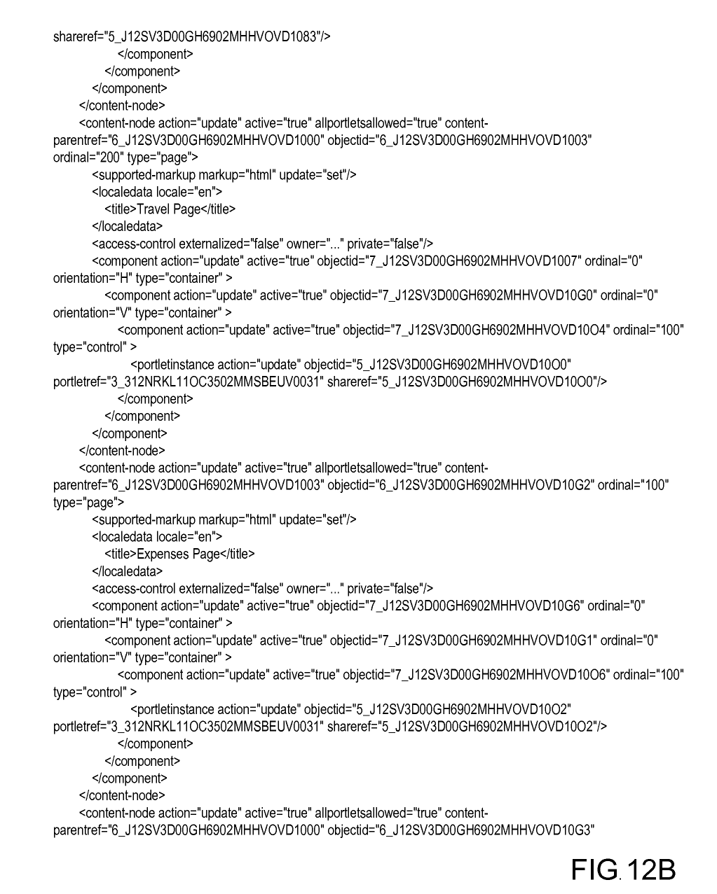

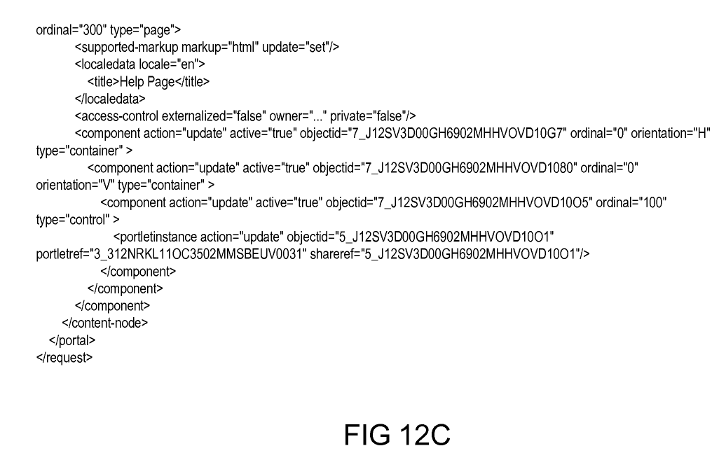

FIG. 9 shows how these portlets are placed on a set of pages (see also FIG. 12, for a sample representation of this information in XML Access format of IBM WebSphere Portal).

The graph in FIG. 9 includes two kinds of nodes (ni): Pages (Pi) and portlets (pi). Relationships between pages and portlets are represented through edges (ei). Nodes or edges may be assigned weights, wherein weights of nodes can, for example, be retrieved from analysis or auditing components of the portal system; in this example only the nodes have weights and the weight W shall be defined as the frequency of use per user group (given a set of user groups gᵢ):

W(ni)=(f_{g1}, . . . , f_{gn})

The present invention can use existing graph evaluation algorithms to evaluate the graph and, based on this analysis, create new graphs which then represent the new composite application definition. In this example, analyzing the weights of the nodes with respect to different user groups shows that some nodes are used by specific user groups. For example users from the “HR” user group often use the employee directory portlet of the information page, but they rarely use the travel booking portlet or the travel expenses portlet. Users of the “manager” user group on the other hand often use the travel booking and travel expenses portlet. The currency calculator is rarely used, for example because the company only operates inside the EU where currency calculations are not necessary for EU-internal business deals or travels. The help desk portlet is used across all user groups to the same degree.

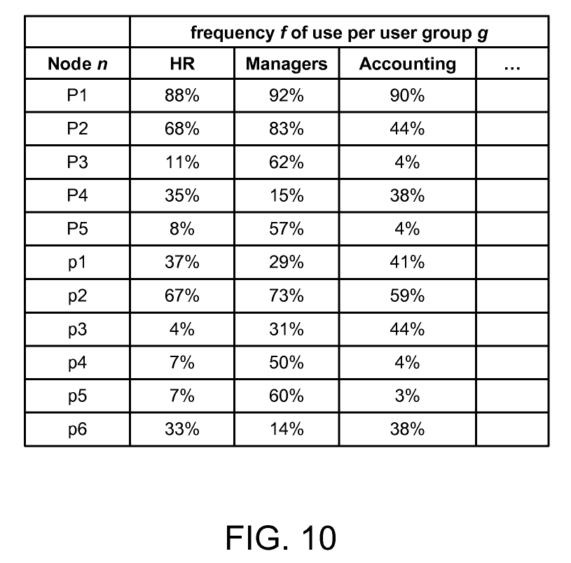

The table of FIG. 10 contains sample data for the nodes of the graph shown in FIG. 9.

In an embodiment of the present invention, the transformation module of the AAC 410 (see, FIG. 4) determines output graphs using the following algorithm described in pseudo code:

```
main ( ):
for each group of user groups
  output graph := transform (weighted input graph)
  output PAA (output graph)
endfor
```

The main loop iterates through all user groups and partitions the weighted input graph for each user group.

```
transform(w.i.g.):
node := root node(input graph)
output graph := new empty graph()
if weight(node) > threshold then
  insert node (node, output graph)
  for each child of children(node)
    merge graph (transform (subtree(child, input graph)), output graph)
  endfor
endif
return output graph
```

The transformation function checks if the weight of the root node of the input graph can be accepted. If so, the node is put into the output graph and all children of the node are analyzed by recursively invoking the transformation for each sub tree defined by each child. Finally the output graph is returned.

Depending on a respective application, it may make sense to post-process the transformation result to avoid meaningless nodes in the graph, e.g., it may not be desirable to output pages without portlets on them.

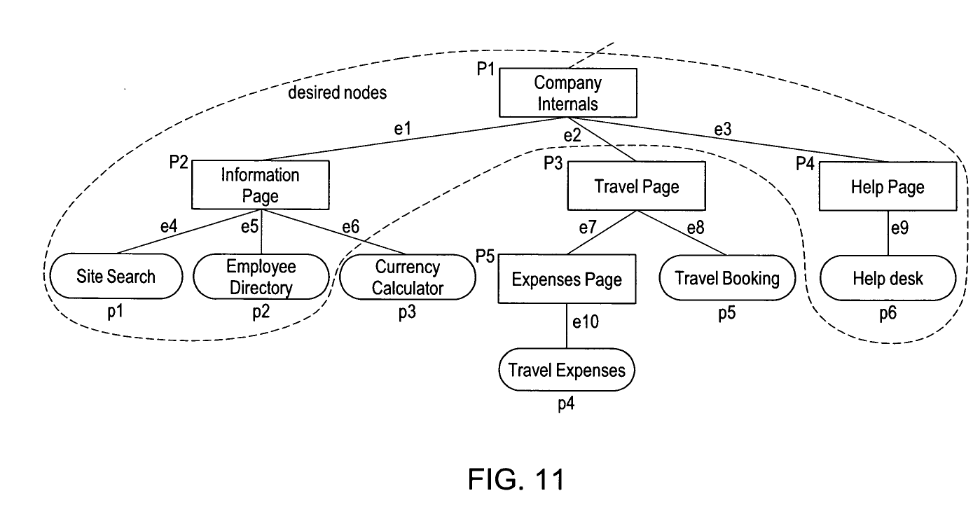

Applying this algorithm to the data shown in FIG. 10 with a threshold of 33% for the HR group, the graph would be partitioned as depicted in FIG. 11. Partitions for all user groups result in composite application suggestions like this, where, for example, the Composite application HR comprises the portal resources P1, P2, P3, p1, p2, p6, e1, e3, e4, e5, e9, etc.:

### Composite Application (HR)=({P1, P2, P4, p1, p2, p6}, {e1, e3, e4, e5, e9}, . . . )

### Composite Application (Mgr)=({P1, P2, P3, P4, P5, p2, p4, p5, p6}, {e2, e3, e5, e7, e8, e9, e10}, . . . )

. . .

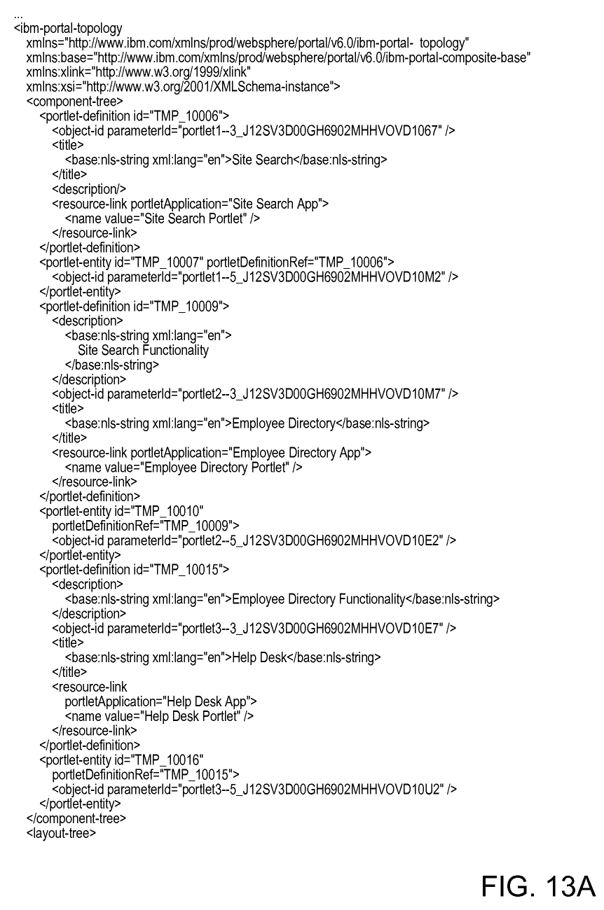

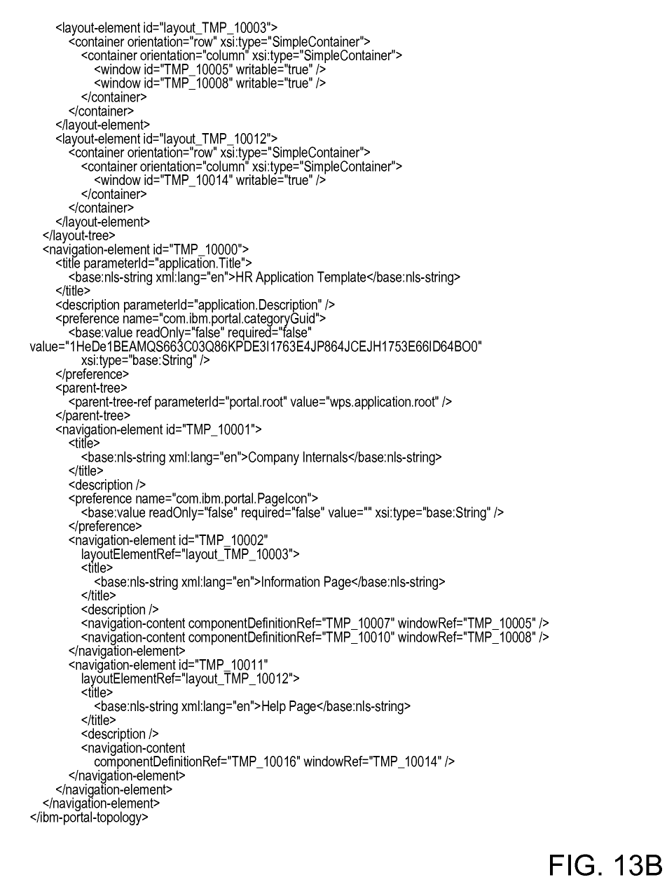

The resulting composite applications are exported into an external representation, for example, into an archive such as PAA. An example of an PAA representation of the “HR Composite Application” is shown in FIGS. 12 A, 12B, 12C. For disclosing extended details, FIGS. 13A, 13B show an excerpt from the composite application definition of the “HR Composite Application”.

The PAA file (or another external representation of the composite application) can be imported in other portals. Here, the PAA is made available to a remote portal, for example, by providing it on a shared file system or by distributing it through e-mail. The process of importing the composite application can be performed manually by an administrator or can be performed automatically by a computer program.

The present invention can be used to automatically define composite applications that comprise all portal resources that are relevant for one user, a group of users, or multiple groups of users. This allows user group specific functionality to be easily distributed between multiple portals.

Some/all aspects of the present invention can be provided on a computer-readable medium that includes computer program code for carrying out and/or implementing the various process steps of the present invention, when loaded and executed in a computer system. It is understood that the term “computer-readable medium” comprises one or more of any type of physical embodiment of the computer program code. For example, the computer-readable medium can comprise computer program code embodied on one or more portable storage articles of manufacture (e.g., a compact disc, a magnetic disk, a tape, etc.), on one or more data storage portions of a computer system, such as memory and/or a storage system (e.g., a fixed disk, a read-only memory, a random access memory, a cache memory, etc.), and/or as a data signal traveling over a network (e.g., during a wired/wireless electronic distribution of the computer program code).

As used herein, the term “computer program code” refers to any expression, in any language, code or notation, of a set of instructions intended to cause a computer system having an information processing capability to perform a particular function either directly or after either or both of the following: (a) conversion to another language, code or notation; and (b) reproduction in a different material form. The computer program code can be embodied as one or more types of computer program products, such as an application/software program, component software/library of functions, an operating system, a basic I/O system/driver for a particular computing and/or I/O device, and the like.

It should be appreciated that the teachings of the present invention can be offered as a business method on a subscription or fee basis. For example, a service provider (e.g., a provider of cell phone service) can create, maintain, enable, and deploy a text-to-speech assist for portable communication devices, as described above.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for configuring applications in web-based portal environments, wherein on a portal a plurality of application parts are combined to provide a composite portal application, comprising:
automatically capturing and storing user browsing navigation data;
reading portal configuration data corresponding to a user-browsed portal;
automatically analyzing the configuration data and the stored browsing navigation data according to a set of predetermined criteria;
automatically generating configuration data based on a result of the automatic analyses; and
creating from the automatically generated configuration data a representation of a new composite portal application comprising application parts which are typically browsed by a user.

2. The method of claim 1, wherein capturing user browsing navigation data comprises:
automatically tracking events triggered by user actions when browsing an existing website portal; and
logging the events.

3. The method of claim 2, wherein tracking the events is done asynchronously with an occurrence of the events.

4. The method of claim 2, wherein tracking the events is done synchronously with an occurrence of the events.

5. The method of claim 1, wherein capturing user browsing navigation data comprises:
automatically reading logged user browsing navigation data from respective log files.

6. The method of claim 1, wherein the portal configuration is based on a graph representation, and wherein a graph node is weighted based on a frequency of navigating to the node.

7. The method of claim 1, wherein the portal configuration is based on a graph representation, and wherein a graph edge is weighted based on a frequency of navigating along the edge.

8. The method of claim 1, wherein the predetermined criteria comprise:
the location of a node on a web page, a top/bottom arrangement of a node, and a distance between different parts of the composite application.

9. A computer system for configuring applications in web-based portal environments, wherein on a portal a plurality of application parts are combined to build a composite portal application, comprising:
a system for automatically capturing and storing user browsing navigation data;
a system for reading portal configuration data corresponding to a user-browsed portal;
a system for automatically analyzing the configuration data and the stored browsing navigation data according to a set of predetermined criteria;
a system for automatically generating configuration data based on a result of the automatic analyses; and
a system for creating from the automatically generated configuration data a representation of a new composite portal application comprising application parts which are typically browsed by a user.

10. The system of claim 9, wherein the system for capturing user browsing navigation data comprises:
a system for automatically tracking events triggered by user actions when browsing an existing website portal; and
a system for logging the events.

11. The system of claim 10, wherein the events are tracked asynchronously with an occurrence of the events.

12. The method of claim 10, wherein the events are tracked synchronously with an occurrence of the events.

13. The system of claim 9, wherein the system for capturing user browsing navigation data comprises:
a system for automatically reading logged user browsing navigation data from respective log files.

14. The system of claim 9, wherein the portal configuration is based on a graph representation, and wherein a graph node is weighted based on a frequency of navigating to the node.

15. The system of claim 9, wherein the portal configuration is based on a graph representation, and wherein a graph edge is weighted based on a frequency of navigating along the edge.

16. The system of claim 9, wherein the predetermined criteria comprise:
the location of a node on a web page, a top/bottom arrangement of a node, and a distance between different parts of the composite application.

17. A program product stored on a computer readable medium, which when executed, configures applications in web-based portal environments, wherein on a portal a plurality of application parts are combined to build a composite portal application, the computer readable medium comprising program code for:
automatically capturing and storing user browsing navigation data;
reading portal configuration data corresponding to a user-browsed portal;
automatically analyzing the configuration data and the stored browsing navigation data according to a set of predetermined criteria;
automatically generating configuration data based on a result of the automatic analyses; and
creating from the automatically generated configuration data a representation of a new composite portal application comprising application parts which are typically browsed by a user.
